(19) United States
(12) Patent Application Publication
(10) Pub. No.: US 2017/0225733 A1
(43) Pub. Date: Aug. 10, 2017

(54) RESTRICTION UNIT FOR ADJUSTMENT OF SEAT POST

(71) Applicant: KIND SHOCK HI-TECH CO., LTD., TAINAN CITY (TW)

(72) Inventor: JUNG YU HSU, TAINAN CITY (TW)

(21) Appl. No.: 15/015,725

(22) Filed: Feb. 4, 2016

(51) Int. Cl. B62J 1/08

(52) U.S. Cl. CPC B62J 1/08; B62J 2001/085

(57) ABSTRACT

A seat post adjustment device includes an outer tube and an inner tube which has the first end thereof inserted into the outer tube, and a seat is connected to the second end of the inner tube. An adjustment unit is connected to the inner tube, the adjustment unit and the inner tube are linearly movable for a travel distance in the outer tube. An end member is connected to the lower end of the outer tube. A restriction unit is located in the outer tube and has a restriction member which has a length and can be cut when needed such that the travel distance of the inner tube in the outer tube is restricted when the adjustment unit contacts the restriction member.

When the adjustment unit contacts the restriction member, the minimum height of the second end of the post beyond the outer tube is set.

### BACKGROUND OF THE INVENTION

1. Fields of the invention

The present invention relates to a seat post adjustment device, and more particularly, to a restriction unit for restricting the travel distance of the seat post in the seat tube.

### 2. Descriptions of Related Art

The conventional bicycle seat is connected to the top of the seat post which is movably inserted in the seat tube. The height of the seat is adjustable to meet the requirements of different users.

One of the conventional adjustment device uses hydraulic liquid to linearly move the seat post in the seat tube and to maintain the position of the seat post relative to the seat tube. Another conventional adjustment device uses the combination of pneumatic and hydraulic mechanism to linearly move the seat post in the seat tube and to maintain the position of the seat post relative to the seat tube. Yet another conventional adjustment device uses mechanical method to achieve the above mentioned purposes.

However, the travel distance of the seat post is set and cannot change, that is to say, the user cannot shorten the travel distance of the seat post or to restrict the range that the seat post moves. Therefore, when adjusting the height of the seat, the user has to spend a long time to adjust the seat post relative to the seat tube by operating the locking unit between the seat post and the seat tube. These processes are repeated several times until the seat is finally set at the desired position.

When the adjustment is applied to a bicycle with two seats, the user must spend more time on the adjustment. The seat should be lowered before carrying the bicycles to trains or public transportation vehicles, the conventional adjustment is obviously not efficient and convent to the users.

One of the conventional adjustment device known to applicant includes a quick-release unit connected to the top open of the seat tube so that when the seat post is moved to the desired position, the quick-release is operated to lock the seat post. The seat post has multiple stop members protruding from the outside thereof. A spring is biased the stop member to keep the stop member protruding from the outside of the seat post. The seat tube has a hole so that one of the stop member is engaged with the hole. A releasing lever is located at the hole so that when the user pushes the lever, the lever pushes the stop member to disengage from the hole to quickly release the locked status between the seat post and the seat tube.

Another conventional adjustment device known to applicant includes a knob unit which has a knob unit, a cable unit and a handle unit. The cable unit has a cable extending through the axial hole thereof. The knob unit has a cover, a spring, a protrusion, a seat and an engaging member. The cover has a central hole and a recess is defined in the front of the cover. Threads are formed in the periphery of the recess. The protrusion has a clamp hole and is pivotably connected to the connection portion, and the cable extends through one side of the connection portion. The seat has another recess and a hole is defined through the bottom of the recess so that the protrusion is movably inserted into the hole of the recess of the seat. The cable extends from one end of the cable unit and extends through the side of the connection portion and then extends through the hole of the knob. The spring is mounted to the cable and has one end connected to the bottom of the recess of the cover, and the other end of the spring contacts the bottom of the protrusion, such that the cable extends through the clamp hole and is clamped in the clamp hole. The seat has a tube extending from each other two sides of the rear end thereof so as to secure the seat to the bicycle. The engaging member is located in the recess of the cover and the two ends of the engaging are respectively in contact with the cover and the spring. The seat has threads formed at the front end and the threads are connected to the threads of the recess of the cover to connect the spring and the protrusion be positioned in the recess of the knob unit so as to fix the knob unit to the bicycle. The hole of the seat is located corresponding to the adjustment hole of the seat tube, and the protrusion is biased to be engaged with the hole of the seat tube so as to position the seat post. The other end of the cable is connected to the lever by a securing member.

Yet another conventional adjustment device known to applicant includes a seat tube which has multiple notches, and a seat post is movably inserted into the seat tube. A stop member is located at the seat tube and is radially movable relative to the seat tube. The stop member has a positioning portion on the front end thereof, and the positioning portion is engaged with one of the notches. A first resilient member biases the stop member so that the stop member is pushed toward the outside of the seat tube. A control member is located at the rear end of the stop member and is movable axially along the seat tube. The control member has a contact portion which has a recess in which the stop member is inserted. A cable is connected to the control member and can be operated to push the control member toward the stop member. A second resilient member is located at the control member to normally push the control member toward the stop member.

Nevertheless, all of the conventional adjustment devices known to applicant can only adjust the seat post within a limit range, and the seat post can only be positioned at the position where there is the hole or the notch located. The adjustment cannot meet all of the users' needs. Besides, the engagement between the stop member or the protrusion with the hole or notch cannot be cooperated with the adjustment device using pneumatic cylinder or hydraulic cylinder. The pneumatic cylinder or hydraulic cylinder is able to move the seat post by a stage-less way, however, the above mentioned adjustment devices includes holes or notches at the seat tube so that the advantages of the use of the pneumatic cylinder or hydraulic cylinder are removed.

The present invention intends to provide a restriction unit for restricting the travel distance of the seat post in the seat tube so as to eliminate the shortcomings mentioned above.

### SUMMARY OF THE INVENTION

The present invention relates to a seat post adjustment device and comprises an outer tube and an inner post which has the first end thereof inserted into the outer tube, and a seat is connected to the second end of the inner tube. An adjustment unit is connected to the inner tube, and the adjustment unit and the inner tube are linearly movable for a travel distance in the outer tube. An end member is connected to the bottom end of the outer tube. A restriction unit is located in the outer tube and has a restriction member which has a length and can be cut when needed such that the travel distance of the inner tube in the outer tube is restricted when the adjustment unit contacts the restriction member. When the adjustment unit contacts the restriction member, the minimum height of the second end of the post beyond the outer tube is set.

The primary object of the present invention is to provide a seat post adjustment device which has a restriction unit connected to the outer tube so as to restrict the travel distance of the inner tube relative to the outer tube. The adjustment of the inner tube is stage-less and the position of the seat can be micro-adjusted.

Another object of the present invention is to provide a seat post adjustment device wherein when the lower end of the inner tube contacts the restriction unit, the inner tube cannot be further lowered such that the minimum height of the seat above the outer tube is set.

Yet another object of the present invention is to provide a seat post adjustment device wherein the restriction unit is easily assembled and dis-assembled from the outer tube. When the restriction unit is removed, the original travels distance of the outer tube is retrieved.

A further object of the present invention is to provide a seat post tube adjustment device which can be cooperated with the conventional pneumatic, hydraulic or mechanism adjustment device.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view, partly removed, to show the seat post adjustment device of the present invention;

FIG. 2 is an exploded view of the seat post adjustment device of the present invention;

FIG. 3 is a cross sectional view of the seat post adjustment device of the present invention;

FIG. 4 is a cross sectional view of the seat post adjustment device of the present invention, wherein the adjustment unit contacts the restriction unit;

FIG. 5 is a perspective view, partly removed, to show the second embodiment of the seat post adjustment device of the present invention;

FIG. 6 is a cross sectional view of the second embodiment of the seat post adjustment device of the present invention;

FIG. 7 is a cross sectional view of the second embodiment of the seat post adjustment device of the present invention, wherein the adjustment unit contacts the restriction unit;

FIG. 8 is a perspective view, partly removed, to show the third embodiment of the seat post adjustment device of the present invention;

FIG. 9 is an exploded view of the third embodiment of the seat post adjustment device of the present invention;

FIG. 10 is a cross sectional view of the third embodiment of the seat post adjustment device of the present invention;

FIG. 11 is a perspective view, partly removed, to show the fourth embodiment of the seat post adjustment device of the present invention;

FIG. 12 is a cross sectional view of the fourth embodiment of the seat post adjustment device of the present invention;

FIG. 13 is a perspective view, partly removed, to show the fifth embodiment of the seat post adjustment device of the present invention;

FIG. 14 is an exploded view of the fifth embodiment of the seat post adjustment device of the present invention;

FIG. 15 is a cross sectional view of the fifth embodiment of the seat post adjustment device of the present invention;

FIG. 16 is a perspective view, partly removed, to show the sixth embodiment of the seat post adjustment device of the present invention;

FIG. 17 is an exploded view of the sixth embodiment of the seat post adjustment device of the present invention, and

FIG. 18 is a cross sectional view of the sixth embodiment of the seat post adjustment device of the present invention.

### DETAILED DESCRIPTION OF THE PREFERRED EMBODIMENT

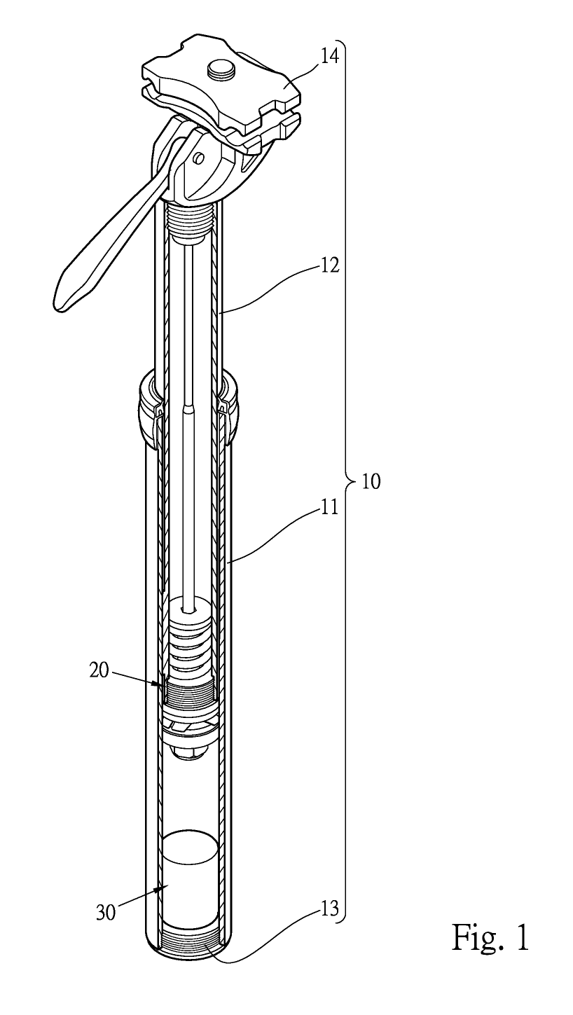

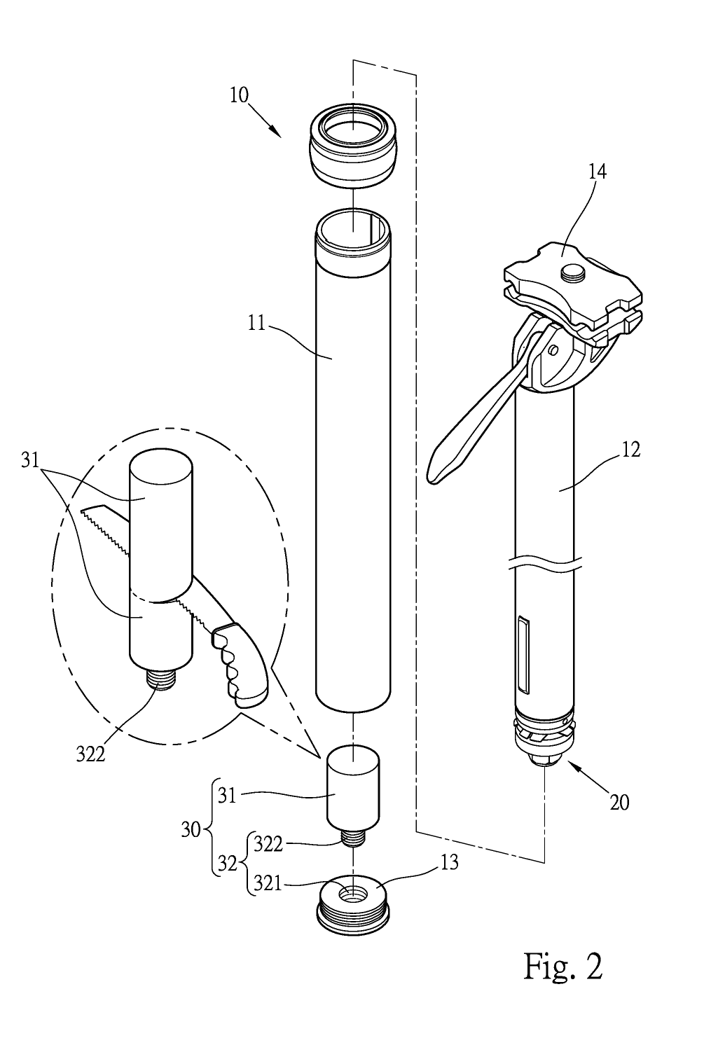

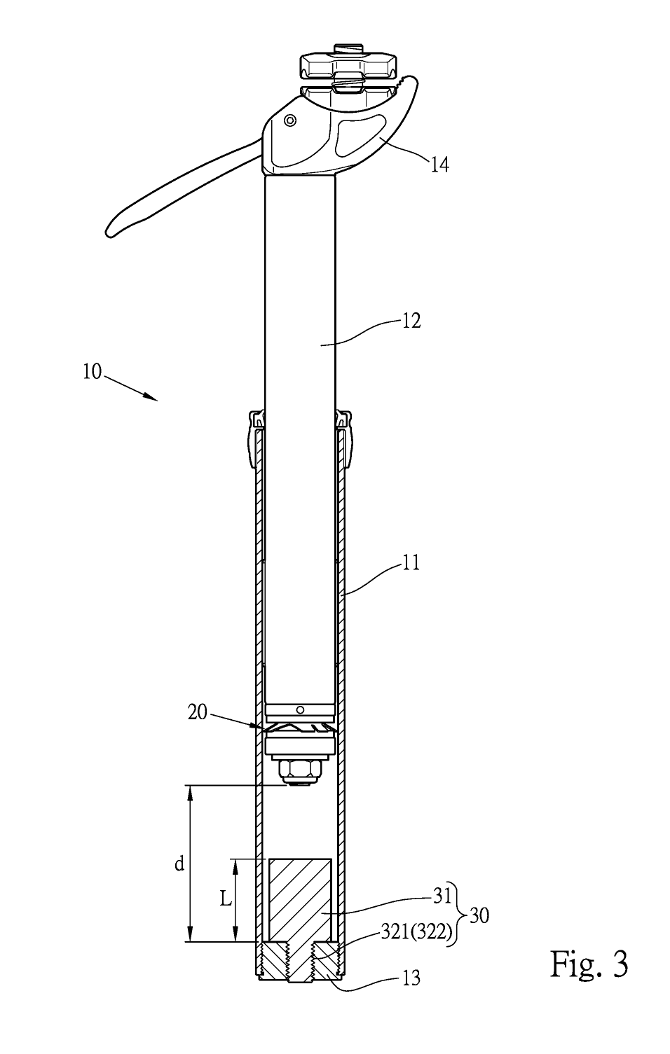

Referring to FIGS. 1 to 3, the seat post adjustment assembly of the present invention comprises a seat post assembly 10, an adjustment unit 20 and a restriction unit 30.

The seat assembly 10 comprises an outer tube 11 and an inner tube 12, wherein the inner tube 12 has the first end thereof inserted into the outer tube 11, and the second end of the inner tube 12 extends beyond the top of the outer tube 11 and is connected with a clamp unit 14 which clamps a seat. An end member 13 is connected to and seals the bottom end of the outer tube 11.

The adjustment unit 20 is connected to the inner tube 12 and located in the outer tube 11. The adjustment unit 20 and the inner tube 12 are linearly movable for a travel distance “d” in the outer tube 11.

The restriction unit 30 is located in the outer tube 11 and has a restriction member 31 which has a certain length and is located in the travel distance “d”. When the adjustment unit 20 and the inner tube 12 are stopped by being in contact with the top of the restriction member 31, the minimum length of the second end of the inner tube 12 beyond the outer tube 11 is set, this means that the lowest position of the seat is set. The restriction member 31 can be cut to obtain a desired length “L”, and the restriction member 31 is connected to the end member 13 so that the maximum travel distance “d” is the distance of the difference between the length “L” and the travel distance “d”. The restriction unit 30 has a connection unit 20 which is located between the restriction member 31 and the end member 13. The connection unit 32 has a first connection portion 321. The restriction member 31 has a second connection portion 322 which is connected to the first connection portion 321. In this embodiment, the first connection portion 321 is threadedly connected to the second connection portion 322.

When the restriction member 31 is cut and positioned in the outer tube 11, the maximum travel distance “d” is set, so that when restriction unit 20 on the inner tube 12 contacts the restriction member 31, the inner tube 12 cannot be further lowered, and the minimum length that the second end of inner tube 12 beyond the top end of the outer tube 11 is set. The adjustment can be completed quickly and efficiently, and in a stage-less way.

When assembling, the adjustment unit 20 is installed in the inner tube 12 and the restriction member 31 to set the height “L” to be the desired length and to set the range of the travel distance “d”. The inner tube 12 is inserted into the outer tube 12, and the first connection portion 321 of the restriction member 31 is threadedly connected to the second connection portion 322 of the end member 13. The end member 13 is connected to the other end of the outer tube 11. The restriction member 31 is located in the lower portion of the outer tube 11. The clamp unit 14 is connected to the exposed end of the outer tube 12.

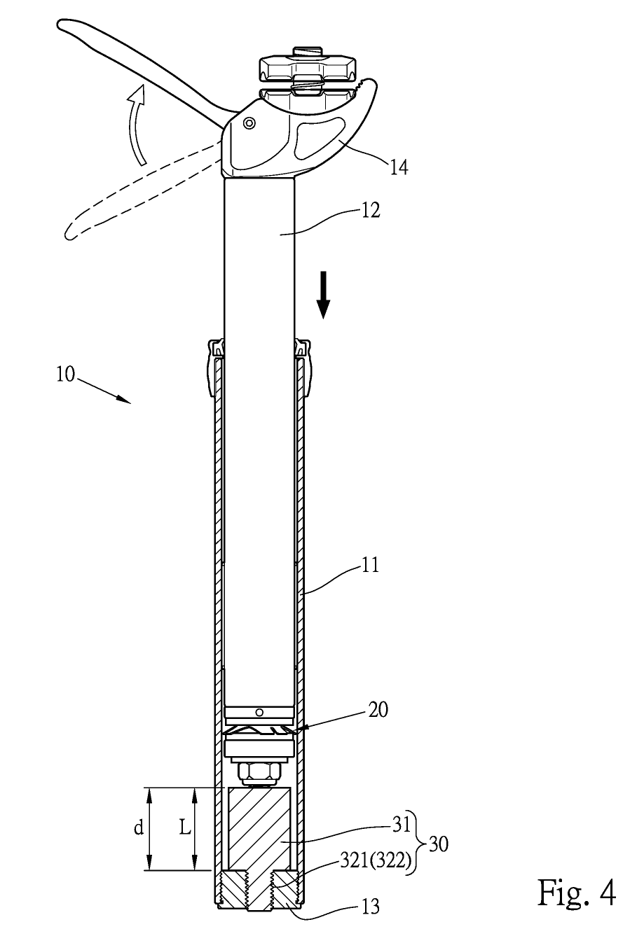

As shown in FIG. 4, when adjusting, the inner tube 12 and the adjustment unit 20 are linearly moved toward the interior of the outer tube 11 until the end face of the adjustment unit 20 contacts the top of the restriction member 31 so that the inner tube 12 and the adjustment unit 20 cannot be further moved. The adjustment action is completed.

The seat post adjustment device includes the following advantages which are that the inner tube 12 and the adjustment unit 20 are moved linearly simultaneously, and the movement is smooth. The adjustment is stage-less and the height of the seat can be micro-adjusted.

The restriction member 31 provides a sufficient length so that the users can cut the restriction member 31 to a desired length “L”. The end member 13 is then connected to the lower end of the outer tube 11. The travel distance “d” is set. The restriction member 31 is used to decide the travel distance “d” and can be adjusted to set the travel distance “d”.

The restriction unit 30 is located in the outer tube 11, and the adjustment unit 20 is stopped by the restriction member 30 such that the lowest position of the bicycle seat is set. In other words, the adjustment can be done by directly lowering the inner tube until the adjustment unit 20 contacts the restriction member 30. The users do not need to spend time to try many times.

The restriction unit 30 is installed in the outer tube 11 without using any other tools, the removal and installation of the restriction unit 30 is quick and easy.

The present invention can be cooperated with the mechanical adjustment device, hydraulic adjustment device and hybrid adjustment device.

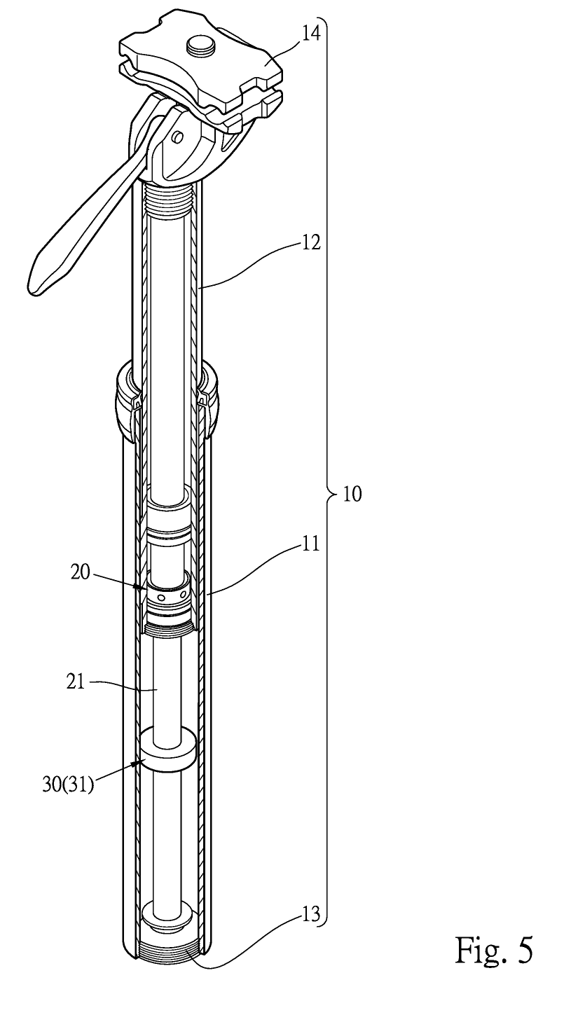

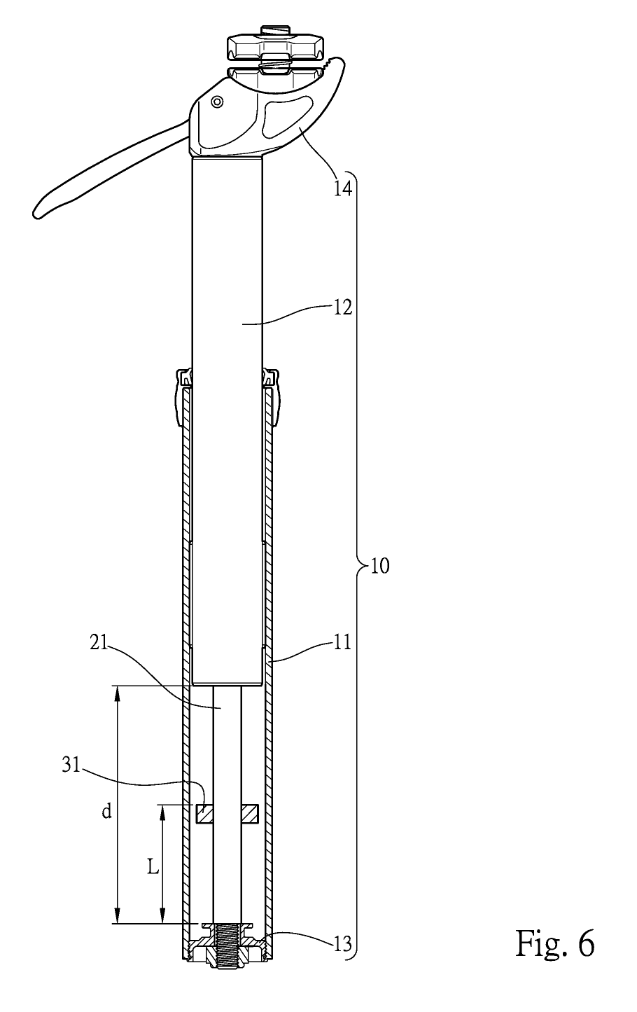

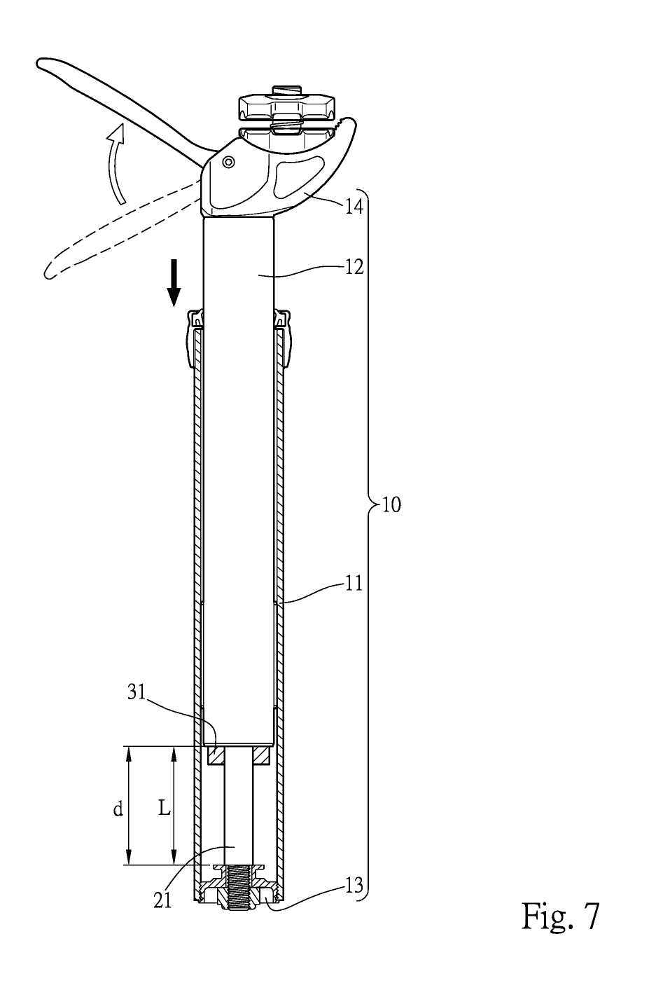

FIGS. 5 to 7 show the second embodiment of the present invention, wherein the adjustment unit 20 has a rod 21 located in the travel distance “d”. The rod 21 has a first end thereof extending beyond the adjustment unit 20 and through the restriction member 31. The first end of the rod 21 is connected to the end member 13. The restriction member 31 is securely mounted to outside of the rod 21. This embodiment is used for the adjustment device whose travel distance “d” having the rod 21. The restriction member 31 has a certain thickness and is tightly mounted to the rod 21 at the position where the length “L” is from the end member 13 to the restriction member 31. When adjusting the inner tube 12, the adjustment unit 20 and the inner tube 12 both move toward the interior of the inner tube 11 until the adjustment unit 20 contacts the restriction member 31.

The embodiment provides another type of the restriction unit 30, and the restriction member 31 is located between two ends of the travel distance “d”.

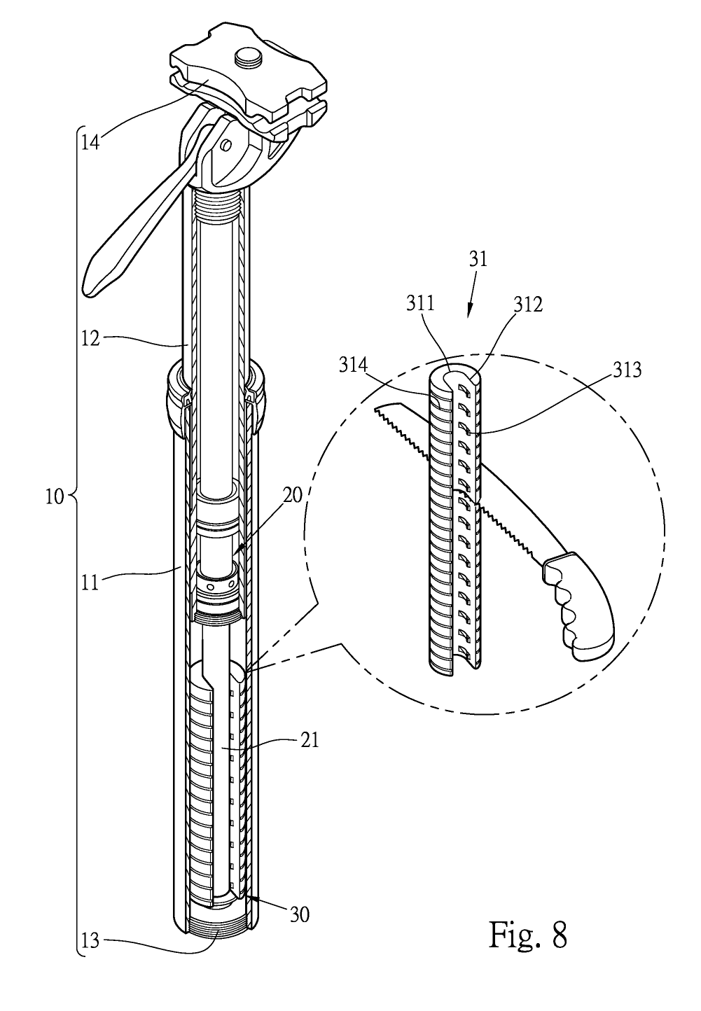

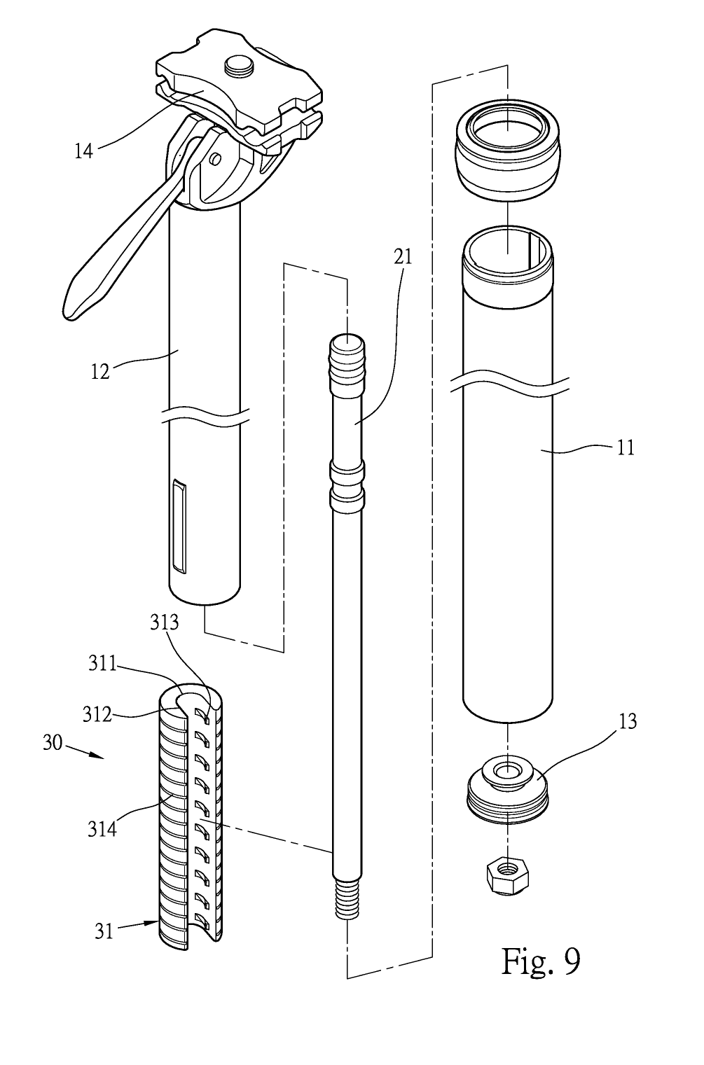

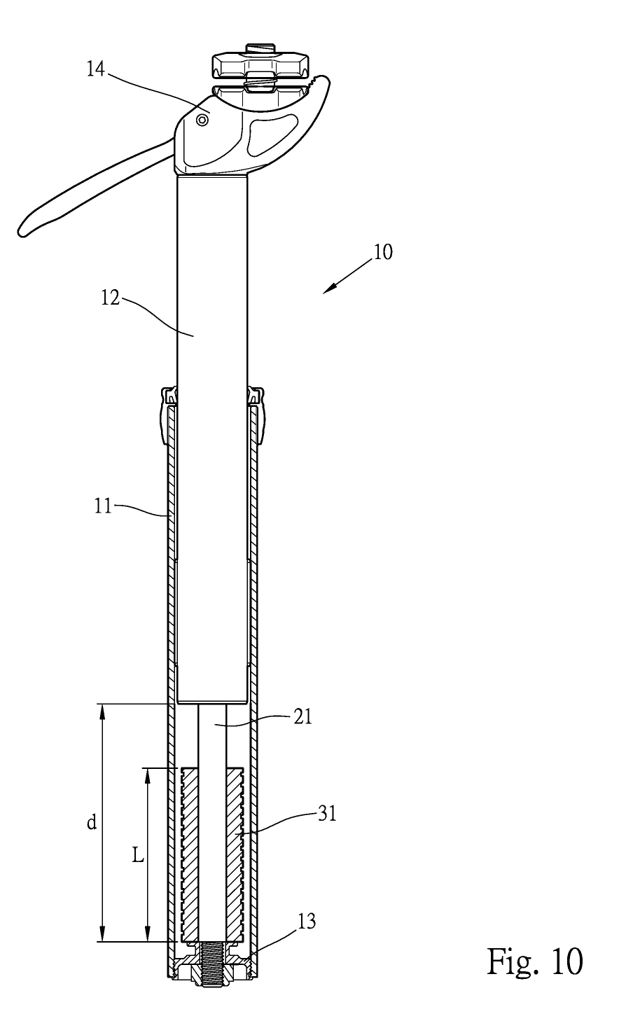

FIGS. 8 to 10 show the third embodiment of the present invention, wherein the adjustment unit 20 has the rod 21 which extends beyond the adjustment unit 20. The exposed portion of the rod 21 extends through the restriction member 31 and is fixed to the end member 13. The restriction member 31 is tightly mounted to the rod 21. The restriction member 31 has a passage 311 defined centrally therethrough, and the restriction member 31 has a slot 312 defined radially therethrough. The slot 312 communicates with the passage 311. The rod 21 is engaged with the passage 311 via the slot 312 from radial direction. Multiple protrusions 313 extend radially from the inner periphery of the restriction member 31 and the protrusions 313 securely contact against the outside of the rod 21. The restriction member 31 has scales 314 marked on the outside thereof and the scales 314 are provided for reference when the restriction member 31 is to be cut.

The embodiment is used for the type of adjustment wherein the end member 13 is connected to the rod or a valve rod, the rod 21 is located between two ends of the travel distance “d”. The restriction member 31 is a cylindrical member and has a certain length. The restriction member 31 has the passage 311 and the slot 312 so as to be connected to the rod 21. The protrusions 313 extend radially from the inner periphery of the restriction member 31 so as to tightly mount to the rod 21.

The scales 314 each can be 1 cm or 0.5 cm, or other system of measurement such that when cutting the restriction member 31, the users do not need a ruler to measure the desired length. In this embodiment, the restriction member 31 is directly connected to the end member 13.

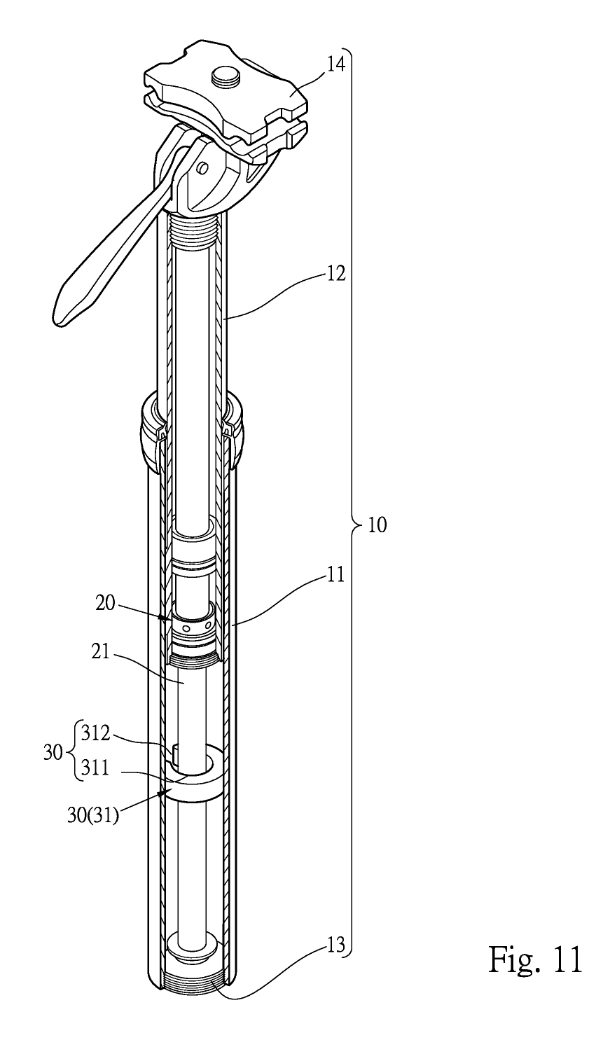

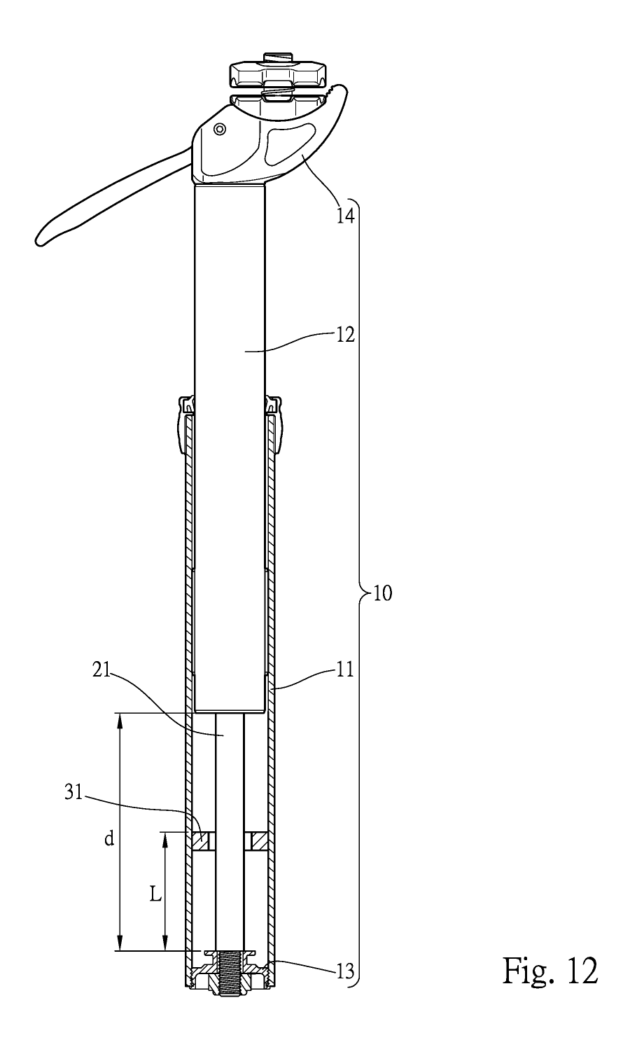

FIGS. 11 to 12 show the fourth embodiment, wherein the restriction member 31 is located in the travel distance “d” in the outer tube 11. The restriction member 31 has a slot 312 defined radially therethrough and the slot 312 communicates with the passage 311. The restriction member 31 is mounted to the rod 21, and the outer periphery of the restriction member 31 is tightly engaged with the inner periphery of the outer tube 11.

The embodiment discloses that the restriction member 31 has a certain thickness and has the slot 312. The restriction member 31 is tightly engaged with the inner periphery of the outer tube 11 at the desired length “L”. The restriction member 31 is located between two ends of the travel distance “d”.

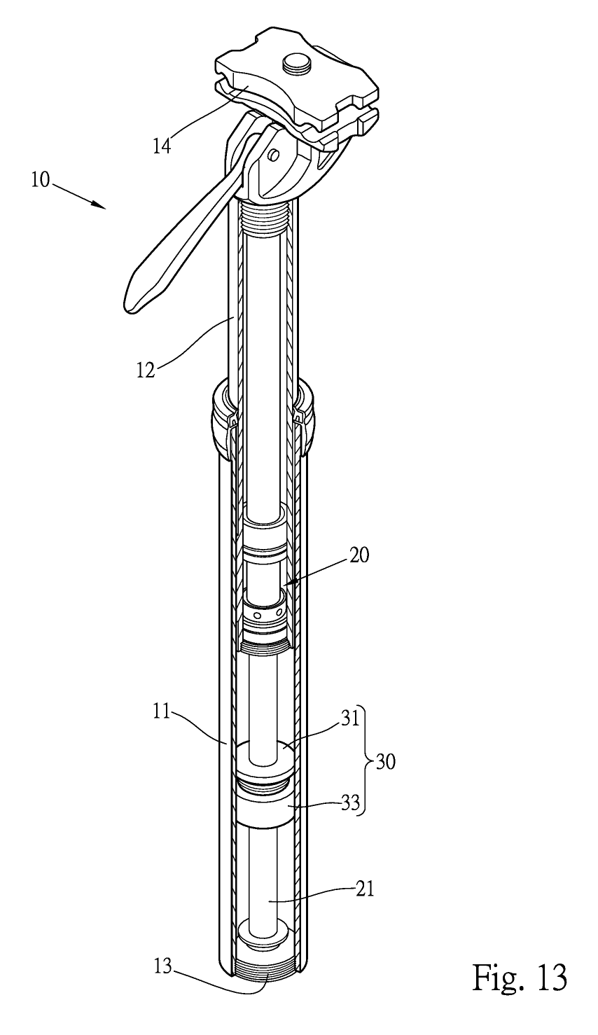

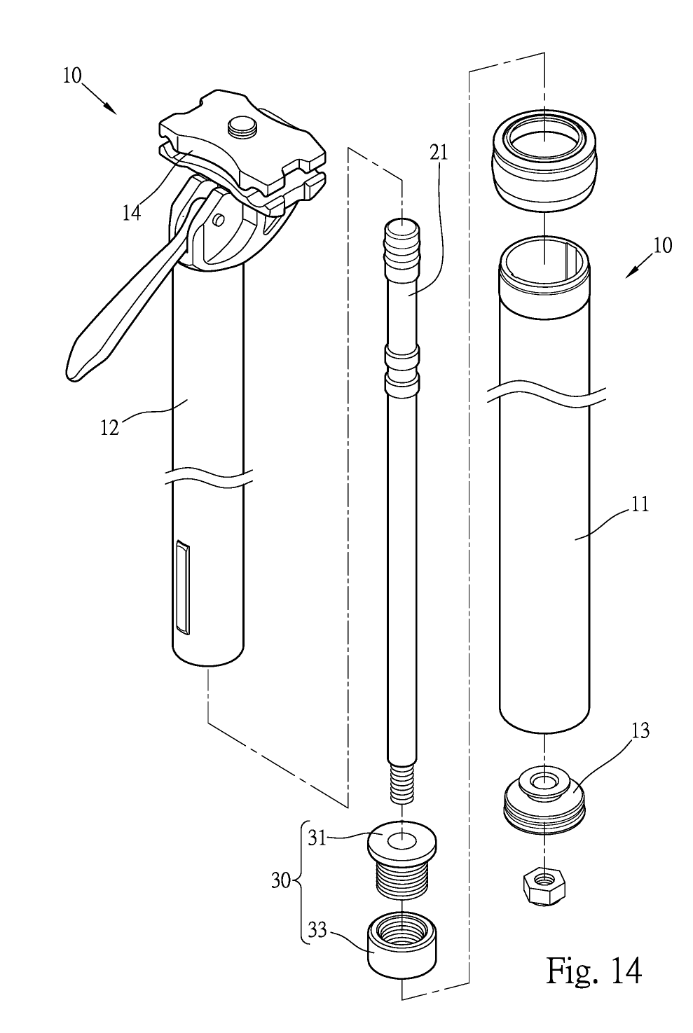

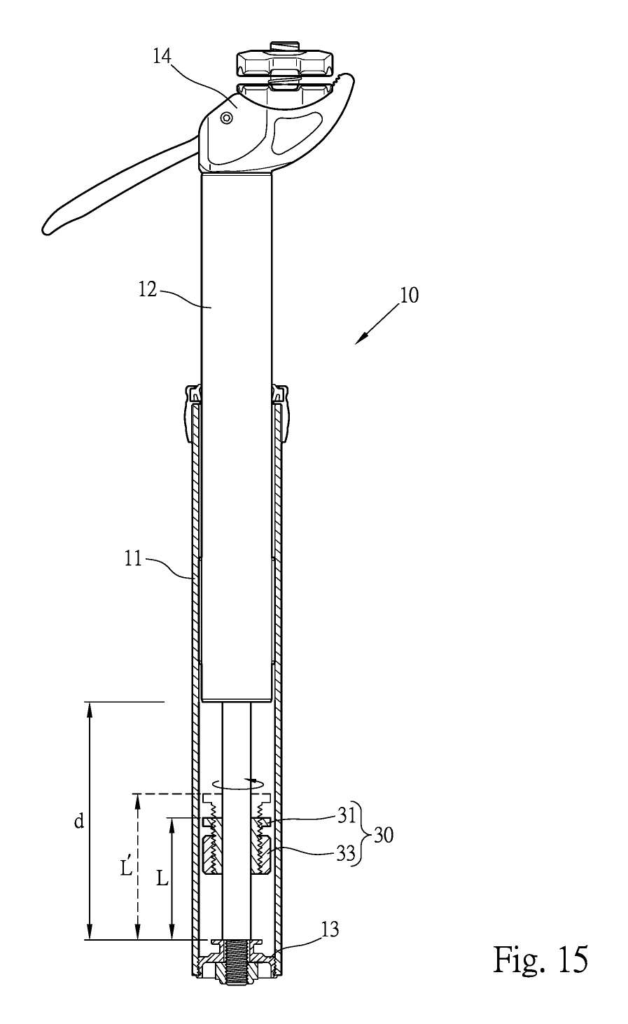

FIGS. 13 to 15 show the fifth embodiment of the present invention, wherein the restriction unit 30 has a first connection member 33 which is axially and threadedly connected to the restriction member 31 so as to adjust the axial length of the restriction unit 30. In other words, the length “L” can be adjusted.

This type of the adjustment device includes the rod 21 connected to the end member 13, and the restriction unit 30 is composed of the restriction member 31 and the first connection member 33. The restriction member 31 is tightly connected to the rod 21 at the length “1”. The first connection member 33 is threadedly connected to the underside of the restriction member 31.

In this embodiment, the restriction member 31 and the first connection member 33 are located between two ends of the travel distance “d”. When adjusting the length “L” of the adjustment unit 20, the restriction member 31 is rotated to increase the length of the restriction unit 30 so that the length is adjusted form “L” to “L′ without using any tool.

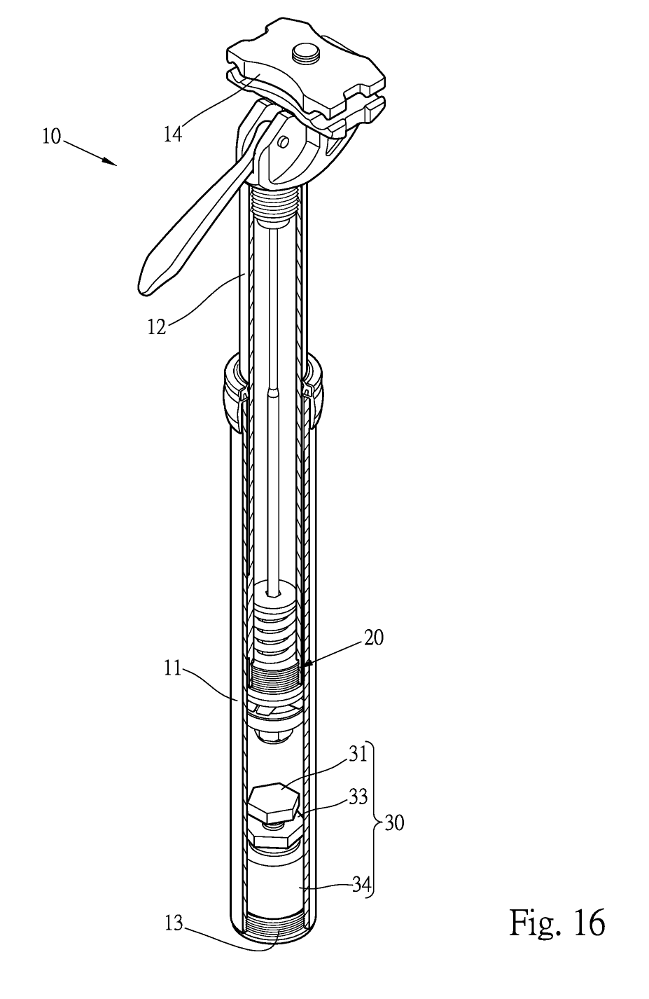

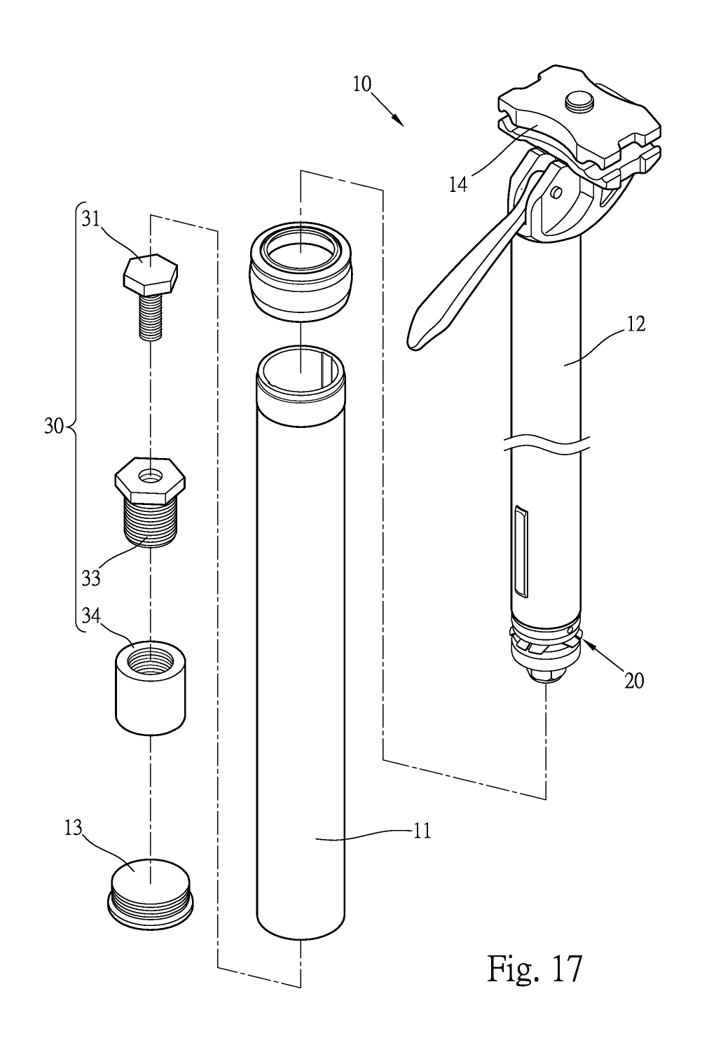

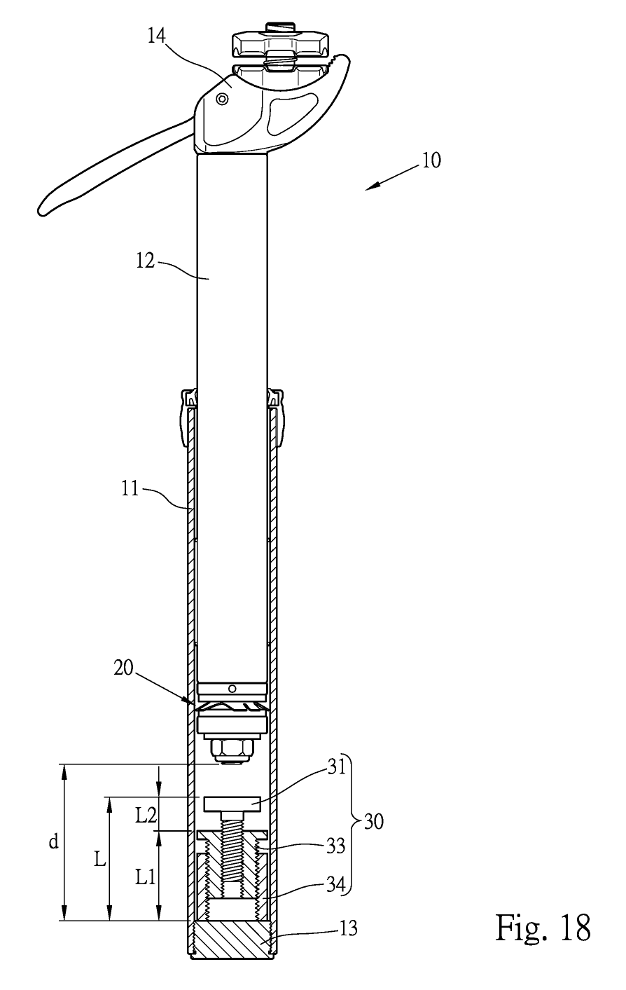

FIGS. 16 to 18 show the sixth embodiment of the present invention, wherein the restriction unit 30 has a second connection member 34 which is axially and threadedly connected to first connection member 33 so as to adjust axial length of the combination of the restriction member 31, the first connection member 33 and the second connection member 34.

This embodiment is used to the type of the adjustment device wherein no rod or valve rod is connected to the end member 13, there is no rod located between two ends of the travel distance “d”. The restriction unit 30 is composed of the restriction member 31, the first connection member 33 and the second connection member 34. The second connection member 34 is connected to the end member 13. The restriction member 31, the first connection member 33 and the second connection member 34 are connected to each other along the same axis.

This embodiment shows that the restriction member 31, the first connection member 33 and the second connection member 34 are directly connected to the end member 13. Because the restriction member 31, the first connection member 33 and the second connection member 34 are threadedly connected to each other so that the first and second connection members 33, 34 can adjust the length “L1”. The restriction member 31 and the first connection member 33 can adjust the length “L2”. The length “L” is the combination of the “L1” and “L2”. The lengths “L1” and “L2” can be individually adjusted.

When rotating the second connection member 34, the length “L1” between the first and second connection members 33, 34 can be adjusted. When rotating the restriction member 31, the length “L2” between the restriction member 31 and the first connection member 33 can adjusted. When adjusting, the end member 13 and the restriction unit 30 are removed from the outer tube 11, and the users can rotate the restriction member 31 and the first connection member 33 to obtain the desired length of the length “L”, and the end member 13 and the restriction unit 30 are installed to the outer tube 11 again to complete the adjustment.

While we have shown and described the embodiment in accordance with the present invention, it should be clear to those skilled in the art that further embodiments may be made without departing from the scope of the present invention.

What is claimed is:

1. A seat post adjustment device, comprising:
a seat post assembly having an outer tube and an inner tube, the inner tube having a first end inserted into the outer tube, a second end of the inner tube extending beyond a top end of the outer tube and connected with a clamp unit which is adapted to clamp a seat, an end member is connected to a bottom end of the outer tube;
an adjustment unit connected to the inner tube, the adjustment unit and the inner tube being linearly movable for a travel distance in the outer tube, and
a restriction unit located in the outer tube and having a restriction member which has a length and is located in the travel distance, when the adjustment unit and the inner tube are stopped by contacting a top of the restriction member, a minimum length of the second end of the inner tube beyond the outer tube is set.

2. The inner tube adjustment device as claimed in claim 1, wherein the restriction unit has a connection unit which is located between the restriction member and the end member, the connection unit has a first connection portion, the restriction member has a second connection portion which is connected to the first connection portion.

3. The seat post adjustment device as claimed in claim 1, wherein the first connection portion is threadedly connected to the second connection portion.

4. The seat post adjustment device as claimed in claim 1, wherein the restriction member is cut to obtain a desired length.

5. The seat post adjustment device as claimed in claim 1, wherein the adjustment unit has a rod located in the travel distance, the rod has a first end thereof extending beyond the adjustment unit and through the restriction member, the first end of the rod is connected to the end member, the restriction member is securely mounted to outside of the rod.

6. The seat post adjustment device as claimed in claim 5, wherein at least one protrusion extends radially from an inner periphery of the restriction member and the at least one protrusion securely contacts against the outside of the rod.

7. The seat post adjustment device as claimed in claim 5, wherein the restriction member has a passage defined centrally therethrough, the restriction member has a slot defined radially therethrough, the slot communicates with the passage, the rod is engaged with the passage via the slot from radial direction.

8. The seat post adjustment device as claimed in claim 1, wherein the restriction member has scales marked on an outside thereof and the scales are provided for reference when the restriction member is to be cut.

9. The seat post adjustment device as claimed in claim 1, wherein the restriction member is engaged with an inside of the outer tube and located between two ends of the travel distance.

10. The seat post adjustment device as claimed in claim 1, wherein the restriction unit has a first connection member which is axially and threadedly connected to the restriction member so as to adjust an axial length of the restriction unit.

11. The seat post adjustment device as claimed in claim 10, wherein the restriction unit has a second connection member which is axially and threadedly connected to first connection member so as to adjust axial length of a combination of the restriction member, the first connection member and the second connection member.
